(19) United States
(12) Patent Application Publication
(10) Pub. No.: US 2026/0163044 A1
(43) Pub. Date: Jun. 11, 2026

(54) BATTERY PACK MANUFACTURING WORKBENCH

(71) Applicant: HONDA MOTOR CO., LTD., Tokyo (JP)

(72) Inventors: Takumi FUJIKAWA, Tokyo (JP); Yoshiharu KATO, Tokyo (JP); Ginga KITASE, Tokyo (JP); Kazuma SAWADA, Tokyo (JP); Yoshinori MORI, Tokyo (JP); Rikki ITO, Tokyo (JP); Nobuhiro NAMBA, Tokyo (JP); Ryosuke KOSUGI, Tokyo (JP)

(21) Appl. No.: 19/351,275

(22) Filed: Oct. 6, 2025

(30) Foreign Application Priority Data
Dec. 10, 2024 (JP) 2024-215179

(51) Int. Cl. H01M 10/04; H01M 50/233; H01M 50/244; H01M 50/256; H01M 50/264

(52) U.S. Cl. CPC H01M 10/0404; H01M 50/233; H01M 50/244; H01M 50/256; H01M 50/264

(57) ABSTRACT

Provided is a battery pack manufacturing workbench for mounting thereon a mounting target that includes a battery pack in which at least some wiring has not been installed. The battery pack manufacturing workbench is provided with a frame base and a tilt apparatus. The frame base is open on a prescribed side in a top surface view. The frame base is configured to allow a transport vehicle, which is in a state of having the mounting target placed thereon, to enter inside from the open side. The frame base is configured to allow the mounting target to be mounted thereon, in a state where the transport vehicle has entered therein. A tilt apparatus tilts the frame base in a state where the mounting target is mounted to the frame base.

This application is based on and claims the benefit of priority from Japanese Patent Application No. 2024-215179, filed on 10 Dec. 2024, the content of which is incorporated herein by reference.

### BACKGROUND OF THE INVENTION

### Field of the Invention

The present invention pertains to a workbench for mounting a battery pack thereon when manufacturing the battery pack.

### Related Art

In recent years, research and development pertaining to electrically driven products that contribute to increasing energy efficiency such as electric vehicles and including hybrid vehicles, for example, has been carried out in order to be able to ensure access to sustainable and advanced energy that can be trusted and can be afforded by more people. In conjunction therewith, also being conducted is research and development pertaining to techniques for manufacturing battery packs that the electrically driven products are equipped with.

Patent Document 1: Japanese Unexamined Patent Application, Publication No. 2011-178546

### SUMMARY OF THE INVENTION

When a battery pack is being manufactured, a worker needs to install prescribed wiring, such as a bus bar, in the battery pack. However, in a case where the battery pack is horizontally large to a certain extent, it will be difficult for the worker to access a central portion or the like from the perimeter of the battery pack. Therefore, it is preferable to facilitate access to the central portion or the like of the battery pack by causing the battery pack to be tilted to a side for setting the battery pack upright. Furthermore, it is preferable to enable a series of tasks for causing the battery pack to be tilted to be performed as easily as possible.

The present invention is made in light of the circumstances described above, and an object of the present invention is to enable a battery pack to be tilted and also enable a series of tasks for performing the tilting to be easily performed.

The inventors accomplished the present invention by finding that it is possible to achieve the object described above if a frame base that allows a transport vehicle in a state where a battery pack is placed thereon can enter inside the frame base is provided and a tilt apparatus for tilting the frame base is also provided. The present invention is a battery pack manufacturing workbench according to the following (1) through (10).

(1) A battery pack manufacturing workbench for mounting thereon a mounting target that includes a battery pack in which at least some wiring has not been installed, the battery pack manufacturing workbench including:
a frame base that is open on a prescribed side in a top surface view, is configured such that a transport vehicle in a state where the mounting target is placed on the transport vehicle is allowed to enter inside the frame base from the open side, and is configured such that the mounting target is allowed to be mounted onto the frame base in a state where the transport vehicle has entered inside the frame base; and
a tilter configured to tilt the frame base in a state where the mounting target is mounted to the frame base.

By virtue of the present configuration, it is possible to allow the transport vehicle to easily enter inside the frame base from the open side. The frame base is configured to allow the mounting target to be mounted onto it in this state. Therefore, the mounting target can be easily transferred from the transport vehicle to the frame base. Moreover, because the tilt apparatus is present, it is possible to tilt the mounting target in place after it has been transferred to the frame base. The mounting target includes a battery pack. Consequently, by virtue of the present configuration, it is possible to enable the battery pack to be tilted, and it is also possible to enable a series of tasks for tilting the battery pack to be easily performed.

(2) The battery pack manufacturing workbench according to (1) above,
the tilter tilting the frame base such that a link side as an opposite side of the open side becomes a lower side, and the open side becomes an upper side.

By virtue of the present configuration, a work side for a worker and an entrance side for the transport vehicle become opposite sides that sandwich the frame base. Therefore, avoiding interference between the worker and the transport vehicle is facilitated.

(3) The battery pack manufacturing workbench according to (1) or (2) above, further including:
a floater configured to use air to floatingly support the mounting target above the frame base; and
a first engager that is provided to the frame base,
the mounting target being provided with a second engager for engaging with the first engager, and
the floater stopping floatingly supporting the mounting target after the mounting target is positioned with respect to the frame base by engagement between the first engager and the second engager during the floating support.

By virtue of this configuration, it is possible to efficiently position the mounting target with respect to the frame base. Moreover, the floating support is stopped after the mounting target is positioned with respect to the frame base by the engagement between the first engager and the second engager. Accordingly, while the frame base is tilted, the mounting target is positioned and secured with respect to the frame base by the engagement between the first engager and the second engager even without being floatingly supported. Accordingly, it is possible to ensure a fail-safe.

(4) The battery pack manufacturing workbench according to (3) above,
the second engager being an engagement hole that extends vertically,
the first engager being an engagement pin that protrudes upward, and
the engagement pin having a tapered shape that upwardly decreases in diameter.

By virtue of this configuration, in a top surface view, even if the center positions of the engagement hole deviates from the center position of the engagement pin to some extent, it is possible to use the tapered shape of the engagement pin to guide the center position of the engagement hole to the center position of the engagement pin.

(5) The battery pack manufacturing workbench according to (3) or (4) above,
the second engager being an engagement hole that extends vertically,
the first engager being an engagement pin that is allowed to protrude upward and to retract downward,
the battery pack manufacturing workbench being provided with
an occupancy sensor for confirming that the mounting target is present on the frame base, and
an engagement sensor for confirming that the engagement pin is protruding upward, and
the floater stopping floatingly supporting the mounting target after the presence of the mounting target is confirmed by the occupancy sensor and the protrusion by the engagement pin is confirmed by the engagement sensor.

By virtue of the present embodiment, the floating support is stopped after it is confirmed by the occupancy sensor and the engagement sensor that the mounting target has been appropriately mounted and positioned. Accordingly, it is possible to avoid a situation in which the floating support is stopped in a state where the mounting target is not appropriately mounted and positioned with respect to the frame base, and is tilted without further modification.

(6) The battery pack manufacturing workbench according to any one of (1) to (5) above, further including:
a lock pin for locking the mounting target to the frame base; and
a lock sensor for confirming that the mounting target is locked to the frame base by the lock pin,
the tilter tilting the frame base after the lock sensor confirms that the mounting target is locked to the frame base.

By virtue of this configuration, it is possible to a avoid a situation in which tilting is performed in a state where locking has not been performed.

(7) The battery pack manufacturing workbench according to any one of (1) to (6) above, further including:
at two sides that sandwich the frame base, a pair of support columns that support the frame base in a manner that allows the frame base to tilt,
the tilter being provided with, at only one of the pair of support columns, an actuator for tilting the frame base.

By virtue of this configuration, it is possible to tilt the frame base by means of only one actuator.

(8) The battery pack manufacturing workbench according to (7) above,
an end of the frame base on the side opposite the actuator being supported by the other of the pair of support columns in a manner that allows tilting.

By virtue of this configuration, it is possible to have the end of frame base on the side opposite the actuator be axial free. Therefore, bending of the frame base is permitted. Therefore, it is possible to smoothly tilt the frame base even by means of only one actuator.

(9) The battery pack manufacturing workbench according to any one of (1) to (8) above,
seen from a lengthwise direction of an axis of the tilting in a state where the frame base is not tilted, a link that corresponds to a portion of the frame base that is on the side opposite the open side having an L shape, the L shape including a base that extends horizontally and a protrusion that protrudes upward from one end of the base, and
in a state where tilting of the frame base is complete, a foot belonging to a worker is allowed to be inserted into a space below the protrusion.

By virtue of the present configuration, it is possible to ensure space for the worker to place their feet, and it will be easier for the worker H to work.

(10) The battery pack manufacturing workbench according to any one of (1) to (9) above,
the mounting target including a pallet on which the battery pack is secured and a bucket that is stored inside the pallet, and
an anti-slip structure for, when the frame base is tilted, preventing the bucket from slipping off by abutting the bucket is provided at a link that corresponds to a portion of the frame base that is on the side opposite to the open side.

By virtue of the battery pack manufacturing workbench according to (1) as above, it is possible to enable a battery pack to be tilted, and it is also possible to enable a series of tasks for performing this tilting to be easily performed. Furthermore, by virtue of the configurations according to (2) through (10) above, which cite (1) above, respective additional effects are achieved.

### BRIEF DESCRIPTION OF THE DRAWINGS

FIG. 1 is a perspective view that illustrates a battery pack manufacturing system according to a first embodiment;

FIG. 2 is a perspective view that illustrates a transport vehicle in a state where a mounting target has been placed thereon;

FIG. 3 is a perspective view that illustrates a pallet for the mounting target;

FIG. 4 is a perspective view that illustrates a battery pack manufacturing workbench;

FIG. 5 is a perspective view that illustrates a state in which the mounting target has been placed onto the battery pack manufacturing workbench;

FIG. 6 is a plan view that illustrates the battery pack manufacturing workbench;

FIG. 7 is a planar cross section that illustrates a state in which the mounting target has been placed onto the battery pack manufacturing workbench;

FIG. 8 is a front cross-sectional view that illustrates an X-side end of the frame base and the periphery thereof;

FIG. 9 is a front cross-sectional view that illustrates an X+side end of the frame base and the periphery thereof;

FIG. 10 is a side-surface cross-sectional view that illustrates a Y-side end of the frame base and the periphery thereof;

FIG. 11 is a side-surface view that illustrates the battery pack manufacturing workbench in a tilting complete state and the periphery thereof;

FIG. 12 is a front cross-sectional view that illustrates an X-side end of a frame base and the periphery thereof, in a second embodiment;

FIG. 13 is a perspective view that illustrates an X-side end of a frame base and the periphery thereof, in a third embodiment; and

FIG. 14 is a side-surface cross-sectional view that illustrates an X-side end of a frame base and the periphery thereof.

### DETAILED DESCRIPTION OF THE INVENTION

With reference to the drawings, description is given below regarding embodiments of the present invention. However, the present invention is not limited whatsoever to the following embodiments, and can be worked after being changed, as appropriate, within a range that does not deviate from the spirit of the present invention.

### First Embodiment

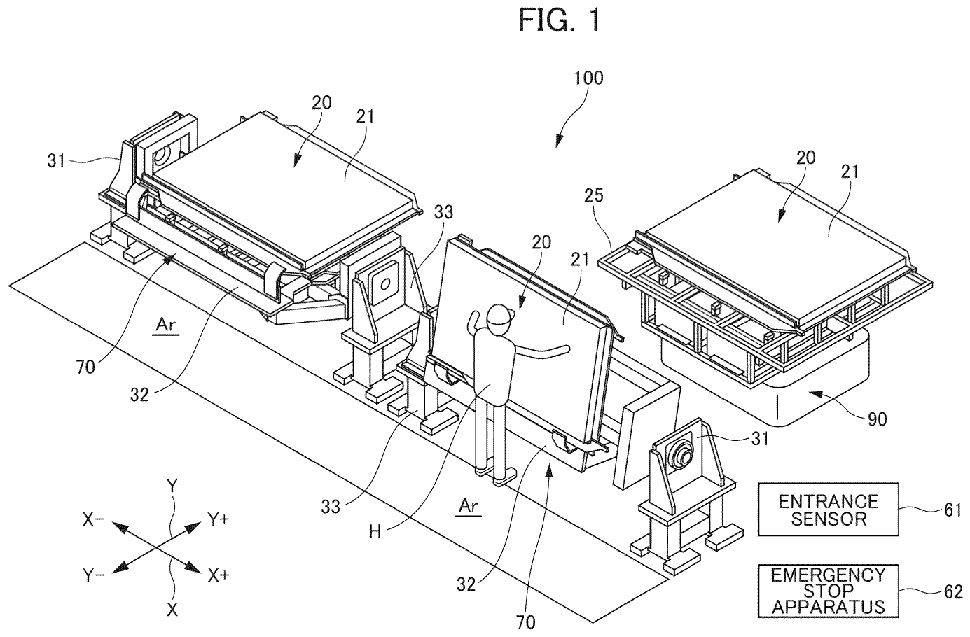

A battery pack manufacturing system 100 that is illustrated in FIG. 1 is for a worker H to efficiently install at least some wiring into a battery pack 21, into which the wiring has not been installed. The battery pack 21 is an intelligent power unit (IPU) or the like, and includes a plurality of batteries. The wiring includes a bus bar or the like.

Two prescribed directions that are orthogonal to each other in a horizontal plane are referred to below as an “X direction” and a “Y direction”. In addition, one side in the X direction is referred to below as the “X− side” and the opposite side is referred to as the “X+ side”. In addition, one side in the Y direction is referred to as “Y− side”, and the opposite side is referred to as the “Y+ side”.

The battery pack manufacturing system 100 includes a workbench 70 and a transport vehicle 90. Note that the workbench 70 may be interpreted as a “battery pack manufacturing workbench”. The transport vehicle 90 transports a prescribed mounting target 20. The workbench 70 and the transport vehicle 90 are controlled by a prescribed control apparatus (not illustrated) that is included in the battery pack manufacturing system 100.

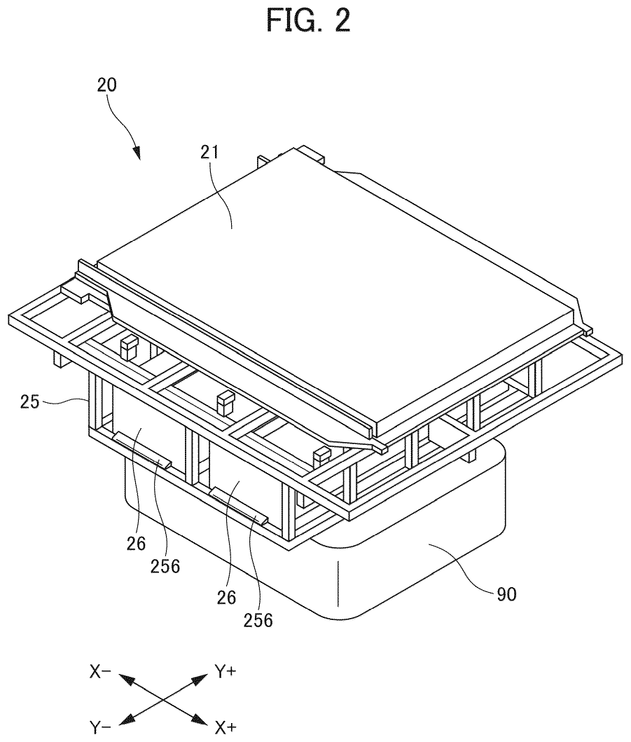

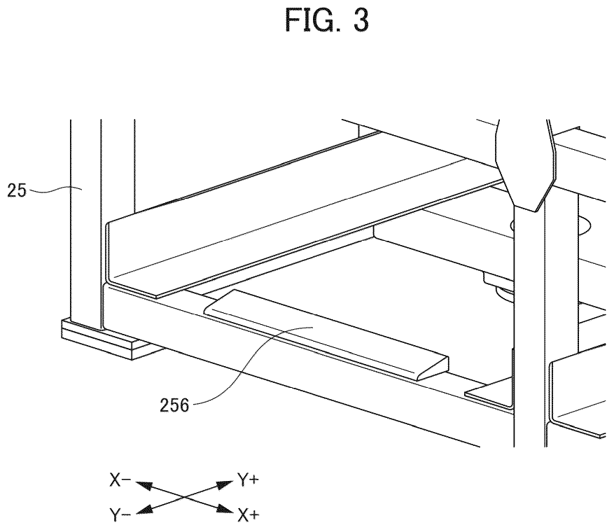

As illustrated in FIG. 2, the mounting target 20 includes the battery pack 21, a pallet 25 onto which the battery pack 21 is secured by screws or the like, and a plurality of buckets 26 that are stored inside the pallet 25. Each bucket 26 stores components for the battery pack 21, tools, or the like, for example.

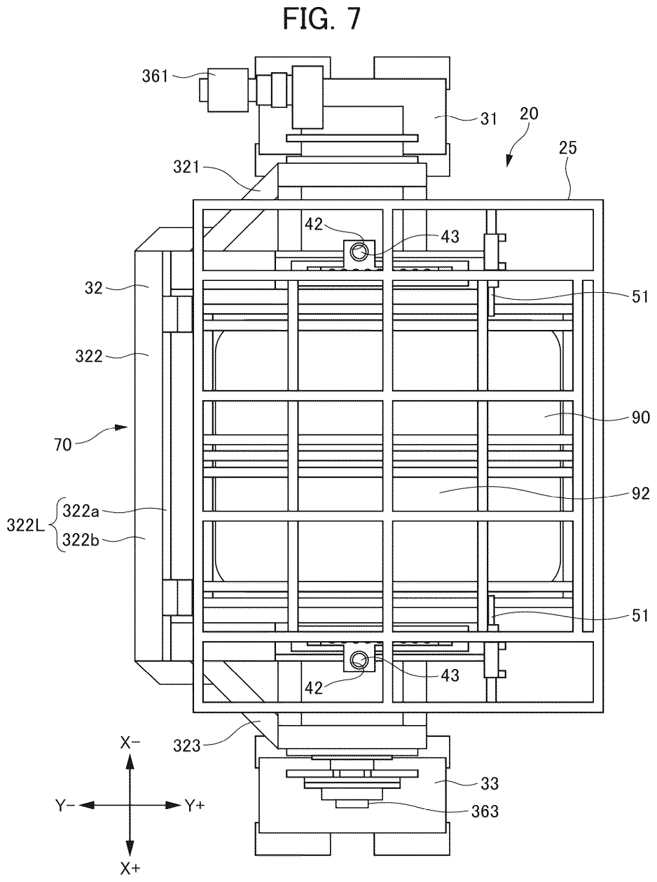

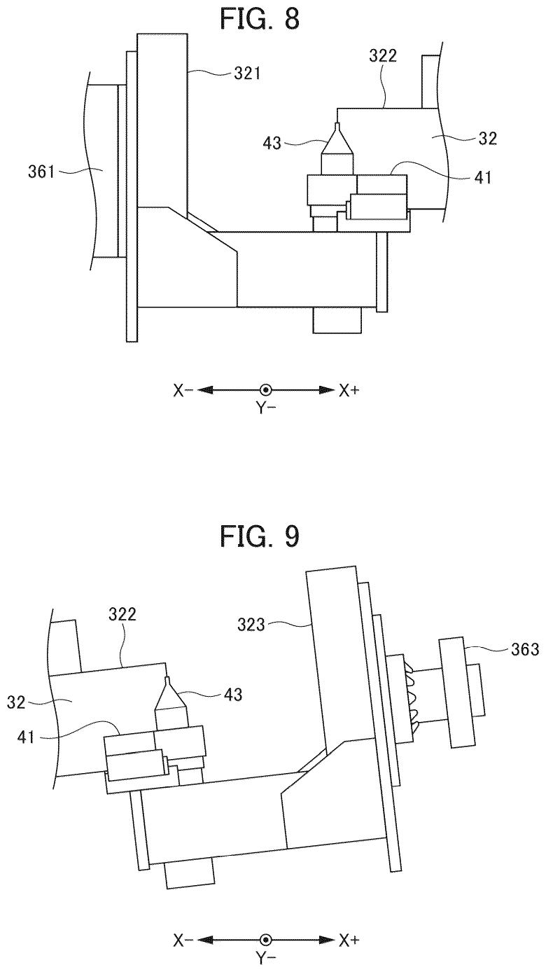

In the present embodiment, the transport vehicle 90 is an automated guided vehicle (AGV) or the like, and is configured to be capable of self-propulsion. As illustrated in FIG. 7, the transport vehicle 90 is provided with a lift 92 for raising and lowering the mounting target 20.

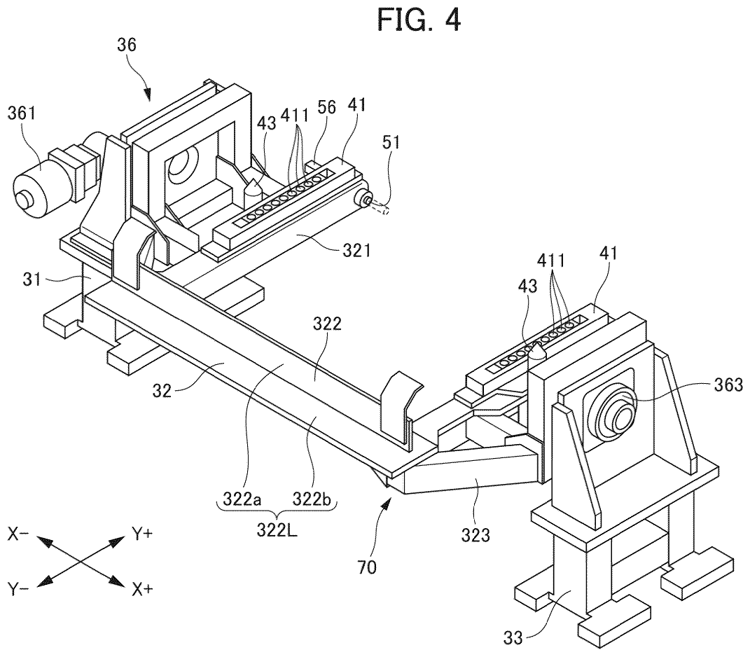

As illustrated in FIG. 4, each workbench 70 is provided with a pair of support columns 31 and 33 that are provided lined up across an interval in the X direction, a frame base 32 provided therebetween, and a tilt apparatus 36. Each of the support columns 31 and 33 extends vertically and in the Y direction. This pair of support columns 31 and 33 support the frame base 32 in a manner that allows the frame base 32 to be tilted around the X direction. Accordingly, the X direction corresponds to the lengthwise direction for the tilt axis. A state in which the frame base 32 is not tilted, as illustrated in FIG. 4, is referred to below as a “basic state”.

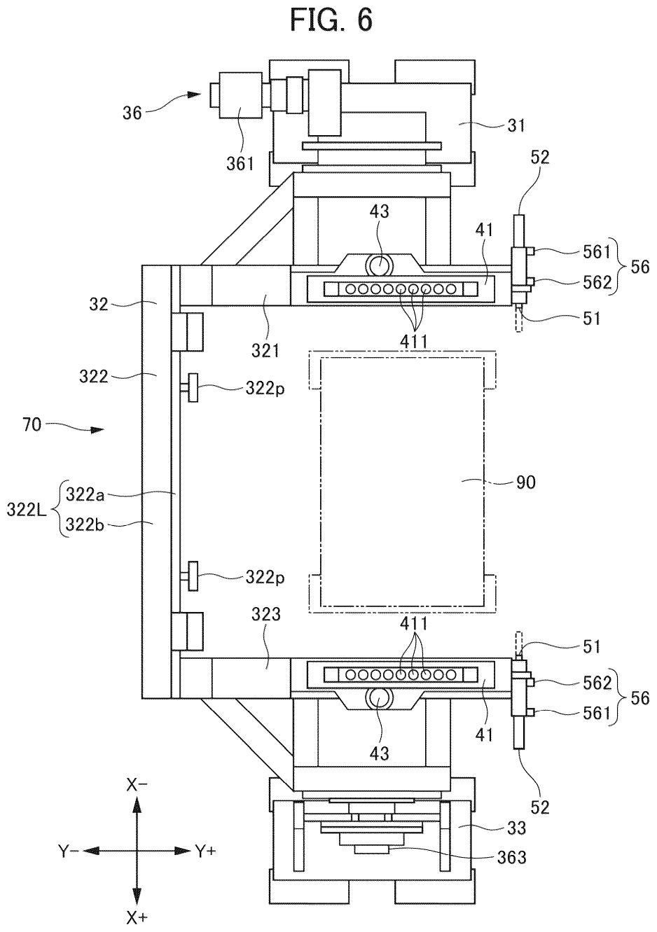

In a top surface view that is illustrated in FIG. 6, the frame base 32 has a U shape that is opened on the Y+ side, in the basic state. Specifically, the frame base 32 is provided with a pair of Y direction-extensions 321 and 323, and a link 322. The pair of Y-axis extensions 321 and 323 are provided lined up across an interval in the X direction. Each of the Y direction-extensions 321 and 323 extends in the Y direction in the basic state. Seen in the basic state, the link 322 links Y-side ends of the pair of Y direction-extensions 321 and 323 to each other. Therefore, the frame base 32 is configured to allow the transport vehicle 90, which is in a state of having the mounting target 20 placed thereon, to enter inside from the Y+ side. The frame base 32, in a state where the transport vehicle 90 has entered therein, is configured to allow the mounting target 20 to be mounted, as illustrated in FIG. 7.

The tilt apparatus 36 illustrated in FIG. 4 is configured to be able to tilt the frame base 32 to the Y− side, in other words to the side where the Y− side in the basic state becomes the lower side and the Y+ side in the basic state becomes the upper side. A state as illustrated in FIG. 11 in which the frame base 32 has been tilted approximately 60° to the Y− side from the basic state is referred to below as a “tilting complete state”. The tilt apparatus 36 includes an actuator 361 and a bearing 363.

As illustrated in FIG. 4, the actuator 361 is an apparatus for tilting the frame base 32, and is attached to one support column 31. The bearing 363 is attached to the other support column 33. The bearing 363 is a bearing unit, a pillow bearing, or the like, and permits the tilt axis to pivot around the center of the bearing. In other words, the tilt apparatus 36 is provided with the actuator 361 at only the one support column 31, and the end of the frame base 32 at the side opposite the actuator 361 side is supported by the other support column 33 across the bearing 363 in a manner that enables pivoting, while the X direction is employed as an axis of rotation. Consequently, one end of the frame base 32 in the X direction is secured and restrained to a drive shaft on the actuator 361 side, and the other end in the X direction is simply supported in a manner that allows the tilt axis to pivot.

As illustrated in FIG. 2, the pallet 25 has a cage shape that is opened on both sides in the Y direction, seen in a state for circumstances of transferring the mounting target 20 from the transport vehicle 90 to the workbench 70. Both ends of the pallet 25 in the Y direction are provided with an anti-fall structure 256. When the mounting target 20 is caused to move by the transport vehicle 90, the anti-fall structures 256 prevent the buckets 26 from falling by abutting the bottom of the buckets 26.

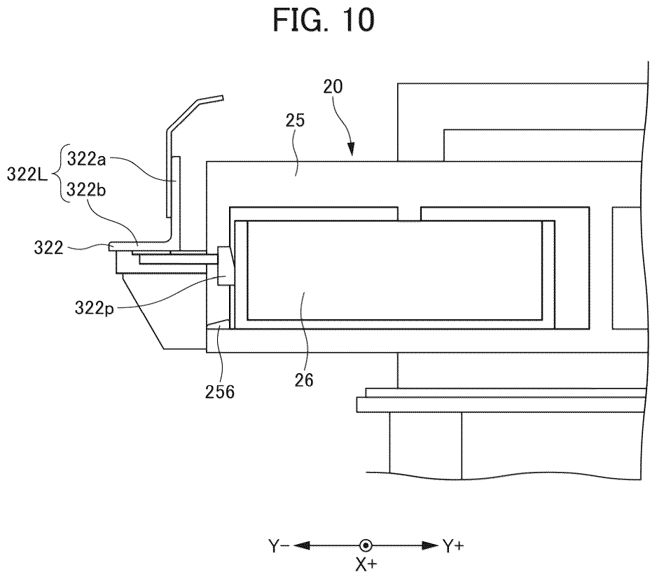

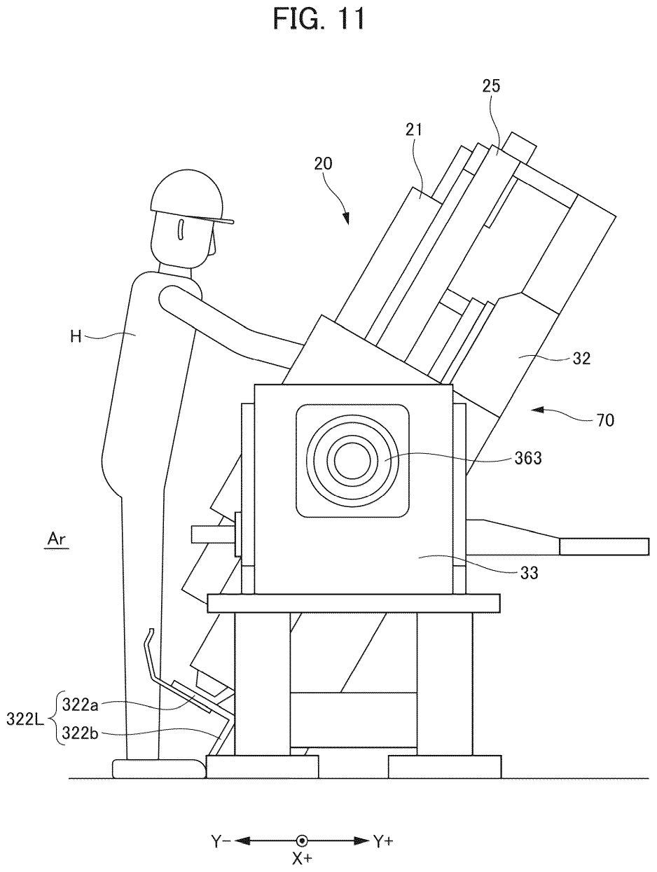

As illustrated in FIG. 10, the link 322 in the frame base 32 includes a base 322b and a protrusion 322a. As illustrated in FIG. 10, when viewed in the X direction in the basic state, the link 322 protrudes in the Y direction, and the protrusion 322a extends upward from the end on the Y+ side of the base 322b. The base 322b is a portion for linking the pair of Y direction-extensions 321 and 323. An anti-slip structure 322p that protrudes on the Y+ side is attached to the bottom surface of the base 322b. When the frame base 32 is tilted, this anti-slip structure 322p abuts the bucket 26 to thereby prevent the bucket 26 from slipping off.

As illustrated in FIG. 11, in a state where the frame base 32 has been tilted, the protrusion 322a is a portion for receiving the mounting target 20 in the unlikely event when a portion or all of the mounting target 20 has slipped off. The link 322 has an L shape 322L that includes the protrusion 322a and the base 322b that are described above. Therefore, in the tilting complete state, the worker H is allowed to insert their feet into the space below the protrusion 322a in this L shape 322L.

As illustrated in FIG. 4, each workbench 70 is also provided with a floating apparatus 41 and an engagement pin 43. The floating apparatus 41 and the engagement pin 43 are each provided for each of the Y direction-extensions 321 and 323. The engagement pins 43 protrude upward from the top surfaces of the Y direction-extensions 321 and 322. Note that each engagement pin 43 may be interpreted as a “first engager”. The engagement pin 43 has a tapered shape that upwardly decreases in diameter.

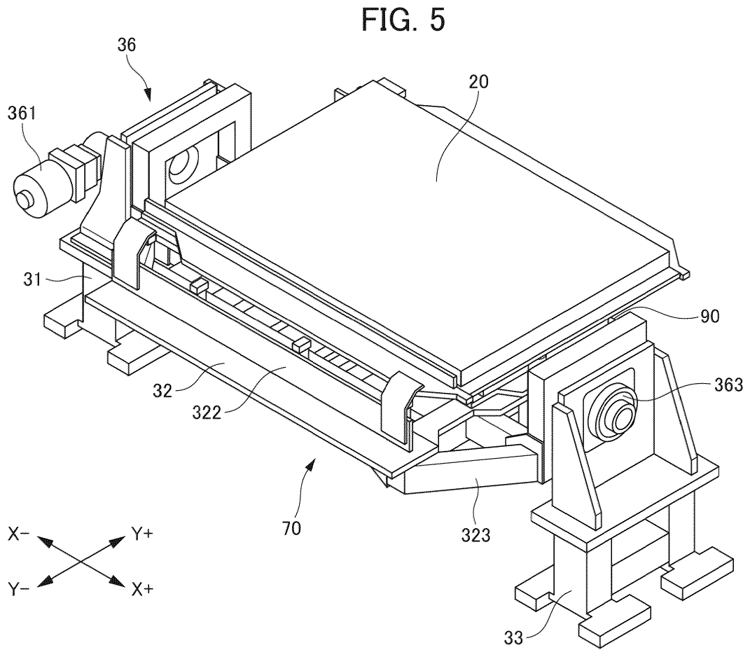

Each floating apparatus 41 is provided with a plurality of air ejection holes 411 that are opened upward, and is configured to be able to discharge air upwardly from the air ejection holes 411. Balls are accommodated in the air ejection holes 411. A configuration is taken such that it is possible to floatingly support the mounting target 20 illustrated in FIG. 5 by causing the balls to float due to air from the air ejection holes 411. As illustrated in FIG. 7, engagement holes 42 that penetrate vertically are provided in the pallet 25 that belongs to the mounting target 20. Note that each engagement hole 42 may be interpreted as a “second engager”. During floating support, the engagement holes 42 are disposed above the engagement pins 43. In a state where floating support is being performed, the engagement pins 43 are inserted into the engagement holes 42, whereby the engagement pins 43 engage with the engagement holes 42 while being guided by the tapered shapes. As a result, the pallet 25 and the battery pack 21 are positioned horizontally with respect to the frame base 32, as seen in the basic state. The floating support is stopped in a state where the engagement pins 43 are inserted in the engagement holes 42, whereby the pallet 25 and the battery pack 21 are mounted to the workbench 70 in a state where the pallet 25 and the battery pack 21 are positioned in a horizontal direction.

As illustrated in FIG. 6, each workbench 70 is provided with, for each of the Y direction-extensions 321 and 323, a lock pin 51, a pin drive apparatus 52, and a lock sensor 56. Each lock pin 51 is configured to be allowed to protrude inward in the X direction and be allowed to retract outward in the X direction, by the pin drive apparatus 52. In state where the mounting target 20 is mounted onto the frame base 32, in other words in a state where the engagement pins 43 are engaged with the engagement holes 42, the lock pins 51 protrude inward in the X direction, whereby the mounting target 20 is locked to the frame base 32. As a result, the engagement holes 42 and the engagement pins 43 cease to be able to disengage. On the other hand, the lock pins 51 are retracted outward in the X direction from this state to thereby release the lock.

Each lock sensor 56 detects whether locking is being performed. Specifically, the lock sensor 56 includes a pin out sensor 561 and a pin return sensor 562. The pin out sensor 561 confirmes that the lock pin 51 has been protruded. The pin return sensor 562 confirms that the lock pin 51 has been retracted. The tilt apparatus 36 tilts the frame base 32 on the condition that locking by the lock pins 51 is confirmed by the lock sensors 56.

Next, description is given regarding a procedure in which the mounting target 20 illustrated in FIG. 5 is placed on the workbench 70 illustrated in FIG. 4, and then the mounting target 20 is tilted as illustrated in FIG. 11.

Firstly, the transport vehicle 90 in a state where the mounting target 20 has been placed thereon as illustrated in FIG. 5 is caused to enter inside the workbench 70 illustrated in FIG. 4. Subsequently, the transport vehicle 90 lowers the mounting target 20 by the lift 92 illustrated in FIG. 7. As a result, the mounting target 20 is transferred from the transport vehicle 90 to the frame base 32. In these circumstances, the above-described floating support is performed. Specifically, the mounting target 20 is mounted to the frame base 32 in a state where the balls in the floating apparatuses 41 are floatingly supported by air. In this state, as described above, the engagement pins 43 are inserted into the engagement holes 42, whereby the engagement pins 43 engage with the engagement holes 42. For the frame base 32 in this state, floating support by the floating apparatuses 41 is stopped, and the mounting target 20 is locked by means of the lock pins 51. Subsequently, the transport vehicle 90 is caused to exit to the Y+ side from inside the frame base 32.

Subsequently, the frame base 32 is tilted approximately 60° by the tilt apparatus 36. In other words, the tilting complete state is entered.

Next, description is given for a procedure for, after wiring work by the worker H has ended, returning the frame base 32 to the basic state illustrated in FIG. 5 from the tilting complete state, and then unloading the mounting target 20 from the workbench 70.

Firstly, the tilt apparatus 36 rotates the frame base 32 from the tilting complete state illustrated in FIG. 11 until the frame base 32 becomes horizontal as illustrated in FIG. 5. In other words, the frame base 32 is returned to the basic state.

Subsequently, the transport vehicle 90 is caused to enter inside the frame base 32. From this state, locking by the lock pins 51 illustrated in FIG. 7 is released. Subsequently, the mounting target 20 is raised by the lift 92 belonging to the transport vehicle 90. As a result, the positioning of the mounting target 20 by the engagement holes 42 and the engagement pins 43 is released, and the mounting target 20 is transferred from the frame base 32 to the transport vehicle 90. Subsequently, the transport vehicle 90 in a state where the mounting target 20 has been placed thereon is caused to exit in the Y+ side from inside the frame base 32.

Note that the above series of operations using the transport vehicle 90 and the workbench 70 is automatically controlled by the control apparatus (not illustrated) in the battery pack manufacturing system.

The configuration and effects of the present embodiment are summarized below.

By virtue of the present embodiment, it is possible to cause the transport vehicle 90 to easily enter inside the frame base 32 from the Y+ side, as illustrated in FIG. 6. The frame base 32 is configured to allow the mounting target 20 to be mounted onto it in this state. Therefore, the mounting target 20 can be easily transferred from the transport vehicle 90 to the frame base 32. Moreover, because the tilt apparatus 36 is present, it is possible to tilt the mounting target 20 in place after it has been transferred to the frame base 32, as illustrated in FIG. 11. Consequently, it is possible to easily perform the series of tasks for transferring the battery pack 21 from the transport vehicle 90 to the workbench 70 and tilting the battery pack 21. Due to this tilting, the worker H will be able to easily access a central portion or the like of the battery pack 21, and be able to easily perform wiring work with respect to the battery pack 21.

The tilt apparatus 36 illustrated in FIG. 4 performs tilting such that the link 322 side for the U-shaped frame base 32 becomes the lower side and the open side becomes the upper side. Therefore, as illustrated in FIG. 1, a work side for the worker H and an entrance side for the transport vehicle 90 are on opposite sides that sandwich the frame base 32 in the Y direction. Therefore, avoiding interference between the worker H and the transport vehicle 90 is facilitated.

As illustrated in FIG. 7, engagement holes 42 that penetrate vertically are provided in the mounting target 20. The floating apparatus 41 illustrated in FIG. 6 floatingly supports the mounting target 20 on the frame base 32. The engagement holes 42 illustrated in FIG. 7 are disposed upward of the engagement pins 43 during the floating support. In a state where the mounting target 20 is floatingly supported, the engagement pins 43 are inserted into the engagement holes 42. As a result, the mounting target 20 is positioned with respect to the frame base 32. Consequently, it is possible to efficiently position the mounting target 20 with respect to the frame base 32. Moreover, floating support is stopped in a state where the engagement pins 43 have been inserted into the engagement holes 42. Accordingly, while the frame base 32 is tilted, the mounting target 20 is positioned and secured with respect to the frame base 32 by the engagement between the engagement holes 42 and the engagement pins 43 even without being floatingly supported. Accordingly, it is possible to ensure a fail-safe.

As illustrated in FIG. 4, the engagement pins 43 have a tapered shape that upwardly decreases in diameter. Accordingly, in the top surface view illustrated in FIG. 7, even if the center positions of the engagement holes 42 deviate from the center positions of the engagement pins 43 to some extent, it is possible to use the tapered shapes of the engagement pins 43 to guide the center positions of the engagement holes 42 to the center positions of the engagement pins 43.

The lock pins 51 illustrated in FIG. 7 lock the mounting target 20 to the frame base 32. The lock sensors 56 illustrated in FIG. 6 confirm that locking has been performed using the lock pins 51. The tilt apparatus 36 performs tilting after the locking is confirmed by the lock sensors 56. Therefore, it is possible to avoid a situation in which tilting is performed in a state where locking has not been performed.

As illustrated in FIG. 4, the workbench 70 has the pair of support columns 31 and 33 that support the frame base 32 in a manner that allows the frame base 32 to tilt. At only one support column 31, the tilt apparatus 36 is provided with the actuator 361 for performing the tilting. Accordingly, it is possible to tilt the frame base 32 by means of only one actuator 361.

As illustrated in FIG. 4, at the end of the frame base 32 at the side opposite the actuator 361, the tilt axis is simply supported in a manner that allows pivoting by the other support column 33 across the bearing 363. Therefore, as illustrated in FIG. 9, bending of the frame base 32 is permitted. Therefore, it is possible to smoothly tilt the frame base 32 even by means of only one actuator 361. Note that, in FIG. 9, the bending is illustrated in an exaggerated fashion in comparison to reality, in order to facilitate visual recognition of the bending.

As illustrated in FIG. 10, seen from the X direction in the basic state, the link 322 in the frame base 32 has the L shape 322L that includes the base 322b that extends in the Y direction and the protrusion 322a that protrudes upward from the end of the base 322b on the Y+ side. Therefore, in the tilting complete state illustrated in FIG. 11, the worker H are allowed to insert their feet below the protrusion 322a in this L shape 322L. Therefore, it is possible to ensure space for the worker H to place their feet, and it will be easier for the worker H to work.

As illustrated in FIG. 10, the link 322 in the frame base 32 is provided with the anti-slip structure 322p that abuts the buckets 26 to thereby prevent the buckets 26 from slipping off when the frame base 32 is tilted. Therefore, it is possible to reduce costs in comparison to a case where such an anti-slip structure 322p is provided for each pallet 25. In addition, in this manner, the anti-slip structure 322p is provided on the workbench 70 side, and thus only functions in the state where the mounting target 20 is placed on the workbench 70. Therefore, in a state where the mounting target 20 is placed on the transport vehicle 90 as illustrated in FIG. 2, the anti-slip structure 322p will not be an obstruction when the worker H takes out the buckets 26.

### Second Embodiment

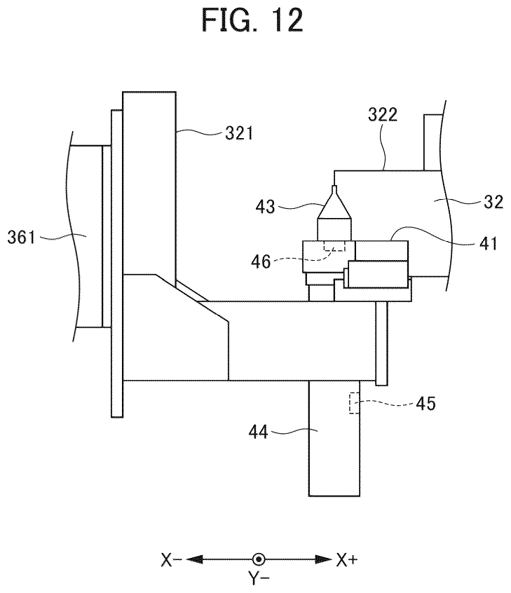

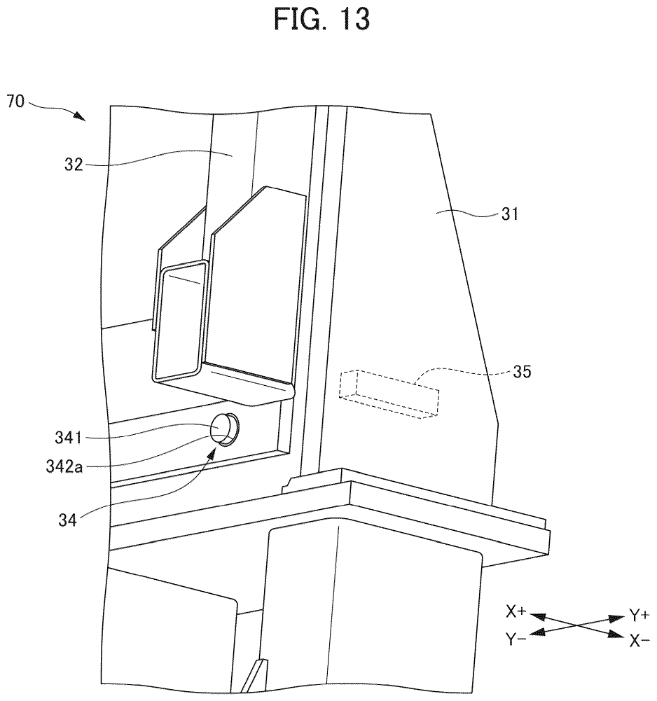

Next, with reference to FIG. 12, description is given regarding a second embodiment. Regarding the following embodiments, description is mainly given for different features based on the first embodiment. Description is omitted, as appropriate, for features that are the same as or similar to those of the first embodiment.

In the present embodiment, an occupancy sensor 46 is provided on the top surface of the frame base 32. This occupancy sensor 46 is for confirming that the mounting target 20 is present on the frame base 32.

Each engagement pin 43 is stored in a cylinder 44 attached to the frame base 32 in a manner that allows movement vertically, and is biased upward by a biasing member (not illustrated) such as a spring. Therefore, the engagement pin 43 is configured to be allowed to protrude upward and be allowed to retract downward.

An engagement sensor 45 is attached to the cylinder 44. This engagement sensor 45 confirms the position of the engagement pin 43, whereby whether the engagement pin 43 is protruding upward or is retracted downward is confirmed.

The workbench 70 inserts the engagement pins 43 into the engagement holes 42 in a state where the mounting target 20 is floatingly supported by the floating apparatus 41. Subsequently, after the presence of the mounting target 20 is confirmed by the occupancy sensor 46 and the protrusion by the engagement pins 43 is confirmed by the engagement sensors 45, the workbench 70 stops the floating support by the floating apparatus 41 and locks the mounting target 20 using the lock pins 51.

By virtue of the present embodiment, the floating support is stopped after it is confirmed by the occupancy sensor 46 and the engagement sensors 45 that the mounting target 20 has been appropriately mounted and positioned. Accordingly, it is possible to avoid a situation in which the floating support is stopped in a state where the mounting target 20 is not appropriately mounted and positioned with respect to the frame base 32, and is tilted without further modification.

### Third Embodiment

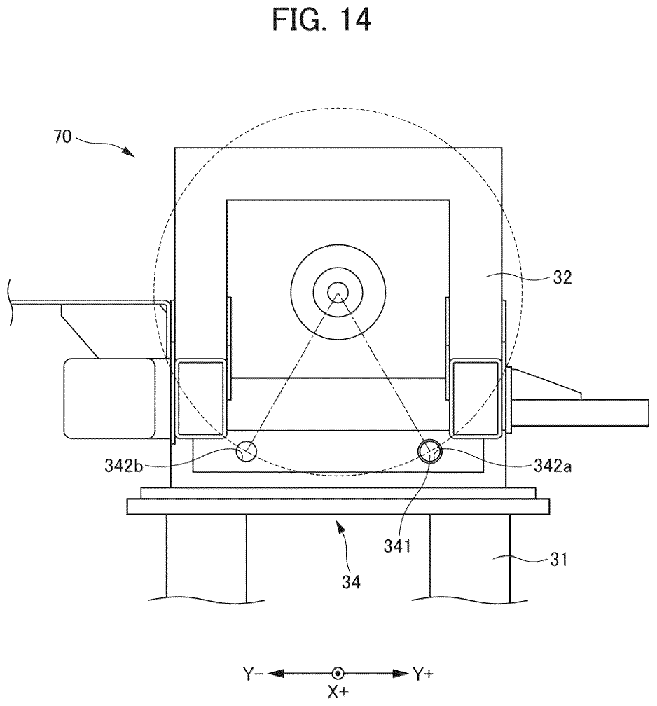

Next, with reference to FIG. 13 and FIG. 14, description is given regarding a third embodiment. In the present embodiment, the workbench 70 is provided with a tilt lock mechanism 34 and a tilt lock sensor 35 at an end in the X direction, as illustrated in FIG. 13. Note that the tilt lock mechanism 34 and the tilt lock sensor 35 may be provided at both ends of the workbench 70 in the X direction, or may be provided only at one end in the X direction.

The tilt lock mechanism 34 it configured to be able to lock the frame base 32 to each of the basic state and the tilting complete state. Such locking by the tilt lock mechanism 34 is referred to below as “tilt locking”. The tilt lock sensor 35 is for confirming whether tilt locking is being performed.

More specifically, as illustrated in FIG. 14, the tilt lock mechanism 34 includes a tilt lock pin 341 that is provided on the support columns 31 and 33 side, and two types of pin holes 342a and 342b that are provided on the frame base 32 side. One pin hole 342a is provided at a position at which engagement with the tilt lock pin 341 is possible in the basic state. The other pin hole 342b is provided at a position at which engagement with the tilt lock pin 341 is possible in the tilting complete state. The tilt lock pin 341 protrudes inward in the X direction from the support columns 31 and 33 side to thereby engage with one of the pin holes 342a and 342b, and retracts outward in the X direction to thereby release the engagement. The tilt lock sensor 35 detects the position of the tilt lock pin 341 to thereby confirm whether tilt locking is underway.

In the basic state, loading of the mounting target 20 onto the workbench 70 by the transport vehicle 90 and unloading of the mounting target 20 from the workbench 70 by the transport vehicle 90 are permitted on the condition that tilt locking is confirmed. In the tilting complete state, a prohibition time period is canceled on the condition that tilt locking is confirmed.

By virtue of the present embodiment, safety is increased due to the tilt lock mechanism 34. Specifically, in circumstances where the actuator 361 attempts to rotate the frame base 32 due to a malfunction, the tilt lock mechanism 34 can prevent this rotation. In addition, even in a case where the frame base 32 freely rotates due to a failure by the actuator 361, this rotation can be prevented by the tilt lock mechanism 34.

In addition, in the basic state, loading and unloading by the transport vehicle 90 is permitted on the condition that tilt locking is confirmed. Accordingly, it is possible to start loading and unload at appropriate timings. In addition, in the tilting complete state, a prohibition time period is canceled on the condition that tilt locking is confirmed. Accordingly, it is possible to cancel the prohibition time period for the worker H at an appropriate timing.

Other Embodiments

The embodiments described above can be modified as follows, for example. The mounting target 20 does not need to include the pallet 25 and the buckets 26. In other words, it may be that the mounting target 20 is only the battery pack 21, and the battery pack 21 is directly mounted to the frame base 32. In addition, if necessary, the battery pack manufacturing system 100 may be provided with a plurality of the transport vehicle 90.

### EXPLANATION OF REFERENCE NUMERALS

20 Mounting target
21 Battery pack
25 Pallet
26 Bucket
31 X-side support column (one support column)
32 Frame base
322 Link
322a Protrusion
322b Base
322L L shape
322p Anti-slip structure
33 X+ side support column (the other support column)
36 Tilt apparatus
361 Actuator
363 Bearing
41 Floating apparatus
43 Engagement hole (second engager)
43 Engagement pin (first engager)
45 Engagement sensor
46 Occupancy sensor
51 Lock pin
56 Lock sensor
70 Workbench (battery pack manufacturing workbench)
90 Transport vehicle
Ar Safety monitoring area

What is claimed is:

1. A battery pack manufacturing workbench for mounting thereon a mounting target that includes a battery pack in which at least some wiring has not been installed, the battery pack manufacturing workbench comprising:
a frame base that is open on a prescribed side in a top surface view, is configured such that a transport vehicle in a state where the mounting target is placed on the transport vehicle is allowed to enter inside the frame base from the open side, and is configured such that the mounting target is allowed to be mounted onto the frame base in a state where the transport vehicle has entered inside the frame base; and
a tilter configured to tilt the frame base in a state where the mounting target is mounted to the frame base.

2. The battery pack manufacturing workbench according to claim 1, wherein
the tilter tilts the frame base such that a link side as an opposite side of the open side becomes a lower side, and the open side becomes an upper side.

3. The battery pack manufacturing workbench according to claim 1, further comprising:
a floater configured to use air to floatingly support the mounting target above the frame base; and
a first engager that is provided to the frame base, wherein
the mounting target is provided with a second engager for engaging with the first engager, and
the floater stops floatingly supporting the mounting target after the mounting target is positioned with respect to the frame base by engagement between the first engager and the second engager during the floating support.

4. The battery pack manufacturing workbench according to claim 3, wherein
the second engager is an engagement hole that extends vertically,
the first engager is an engagement pin that protrudes upward, and
the engagement pin has a tapered shape that upwardly decreases in diameter.

5. The battery pack manufacturing workbench according to claim 3, wherein
the second engager is an engagement hole that extends vertically,
the first engager is an engagement pin that is allowed to protrude upward and to retract downward,
the battery pack manufacturing workbench is provided with an occupancy sensor for confirming that the mounting target is present on the frame base, and
an engagement sensor for confirming that the engagement pin is protruding upward, and
the floater stops floatingly supporting the mounting target after the presence of the mounting target is confirmed by the occupancy sensor and the protrusion by the engagement pin is confirmed by the engagement sensor.

6. The battery pack manufacturing workbench according to claim 1, further comprising:
a lock pin for locking the mounting target to the frame base, and
a lock sensor for confirming that the mounting target is locked to the frame base by the lock pin, wherein
the tilter tilts the frame base after the lock sensor confirms that the mounting target is locked to the frame base.

7. The battery pack manufacturing workbench according to claim 1, further comprising:
at two sides that sandwich the frame base, a pair of support columns that support the frame base in a manner that allows the frame base to tilt, wherein
the tilter is provided with, at only one of the pair of support columns, an actuator for tilting the frame base.

8. The battery pack manufacturing workbench according to claim 7, wherein
an end of the frame base on the side opposite the actuator is supported by the other of the pair of support columns in a manner that allows tilting.

9. The battery pack manufacturing workbench according to claim 1, wherein
seen from a lengthwise direction of an axis of the tilting in a state where the frame base is not tilted, a link that corresponds to a portion of the frame base that is on the side opposite the open side has an L shape, the L shape including a base that extends horizontally and a protrusion that protrudes upward from one end of the base, and
in a state where tilting of the frame base is complete, a foot belonging to a worker is allowed to be inserted into a space below the protrusion.

10. The battery pack manufacturing workbench according to claim 1, wherein
the mounting target includes a pallet on which the battery pack is secured and a bucket that is stored inside the pallet, and
an anti-slip structure for, when the frame base is tilted, preventing the bucket from slipping off by abutting the bucket is provided at a link that corresponds to a portion of the frame base that is on the side opposite to the open side.
